(19) United States
(12) Patent Application Publication
(10) Pub. No.: US 2009/0220088 A1
(43) Pub. Date: Sep. 3, 2009

(54) AUTONOMIC DEFENSE FOR PROTECTING DATA WHEN DATA TAMPERING IS DETECTED

(76) Inventors: Charisse Y. Lu, Austin, TX (US); Emily Jane Ratliff, Austin, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(21) Appl. No.: 12/038,843

(22) Filed: Feb. 28, 2008

(51) Int. Cl. H04L 9/06; G06F 21/00

(52) U.S. Cl. 380/277; 726/23; 713/189

(57) ABSTRACT

A computer implemented method, data processing system, and computer program product for providing an autonomic defense when data tampering is detected in a data processing system where data is maintained and transmitted in unencrypted form. When notification of data tampering activity in the data processing system is received, a determination is made as to whether the data tampering activity meets or exceeds a threshold. If the threshold is met or exceeded, an encryption key is read from a persistent storage location into memory. The key is erased from the persistent storage location. The data in the data processing system is encrypted using the key to form encrypted data. The key is then erased from memory.

### BACKGROUND OF THE INVENTION

1. Field of the Invention

Embodiments of the present invention relate generally to an improved data processing system, and in particular to a computer implemented method, data processing system, and computer program product for providing an autonomic defense when data tampering is detected in the system.

2. Description of the Related Art

Computer network security is of increasing importance due to the often sensitive nature of information stored on commercial and governmental network computers and databases. For example, a bank's Ethernet network computers and databases may contain customer names, account balances, bank account numbers, addresses, phone numbers, social security numbers, and other confidential and personal information. An unauthorized user may be able to access one or more of the bank's computers and/or databases locally from a computer connected to the Ethernet. The bank's computers may also be connected to a remote network, such as the Internet. In such a case, an unauthorized user may be able to obtain access to data in the bank's computer system remotely through the Internet network connection. Consequently, the integrity of a computer's data needs to be protected from illegitimate modification, while other information, such as a password file, needs to be protected from illegitimate disclosure.

Data tampering is defined as the unauthorized, intentional modification or destruction of data. An administrator of a given data processing system may employ many different types of security mechanisms to protect the data within the data processing system. For example, the operating system on a data processing system may provide various software mechanisms to protect sensitive data, such as authentication and authorization schemes, while certain hardware devices and software applications may rely upon hardware mechanisms to protect sensitive data, such as hardware security tokens and biometric sensor devices. Data processing systems which contain extremely sensitive data and sensitive operations that need to be protected may employ self-destruction mechanisms in response to data tampering. For example, data stored in memory or in a storage device may become corrupted due to execution of malicious code executed by a hacker. Data transmitted over a network may be intercepted in transit and modified. When data tampering is detected, the data processing system initiates a self destruct sequence on the disk or data storage mechanism. The self destruct process acts as a “thermite charge”, erasing all of the data on the storage mechanism. By destroying the data, the hacker or unauthorized user cannot access the highly sensitive data.

For systems that contain moderately sensitive data, an encrypted file system is another security mechanism currently used to protect data from unauthorized access. With an encrypted file system, a message that contains sensitive data is protected prior to transport to ensure the security of the data as it flows across the network so that only the intended recipient can access the content of the message. This security technique, commonly known as transport layer security (TLS) or secure sockets layer (SSL), employs cryptographic protocols which provide privacy and data integrity between two communicating applications. The protection occurs in a layer of software on top of the base transport protocol. In many cases, the security provided by a secure sockets layer communications link occurs through the use of encryption technology to ensure the integrity of the message in a network. The secure sockets layer provides confidentiality by ensuring the message content cannot be read. Because communications are encrypted between the sending and receiving parties, a third party is not able to tamper with the message.

With an encrypted file system, however, data encryption at the transport level normally envelops total encryption of all of the data contained within the message. Total encryption is not always efficient because even if only a small portion of the data is sensitive, the entire message is necessarily encrypted and decrypted for the purpose of confidentiality. Additionally, use of an encryption file system may be prohibitively expensive in some systems, since encryption processing hinders system performance.

### BRIEF SUMMARY OF THE INVENTION

The illustrative embodiments provide a computer implemented method, data processing system, and computer program product for providing an autonomic defense when data tampering is detected in a data processing system where data is maintained and transmitted in unencrypted form. When notification of data tampering activity in the data processing system is received, a determination is made as to whether the data tampering activity exceeds a threshold. If so, a pre-defined key is read from a persistent storage location into memory. The key is erased from the persistent storage location. The data in the data processing system is encrypted using the key to form encrypted data. The key is then erased from memory.

### BRIEF DESCRIPTION OF THE SEVERAL VIEWS OF THE DRAWINGS

FIG. 1 depicts a pictorial representation of a distributed data processing system in which the illustrative embodiments may be implemented;

FIG. 2 is a block diagram of a data processing system in which the illustrative embodiments may be implemented;

FIG. 3 is a block diagram of exemplary components which may be used to implement the autonomic defense solution in accordance with the illustrative embodiments;

FIG. 4 is a flowchart of a process for triggering an autonomic defense when tampering is detected in a data processing system in accordance with the illustrative embodiments; and

FIG. 5 is a flowchart of a process for recovering data responsive to execution of an autonomic defense in accordance with the illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

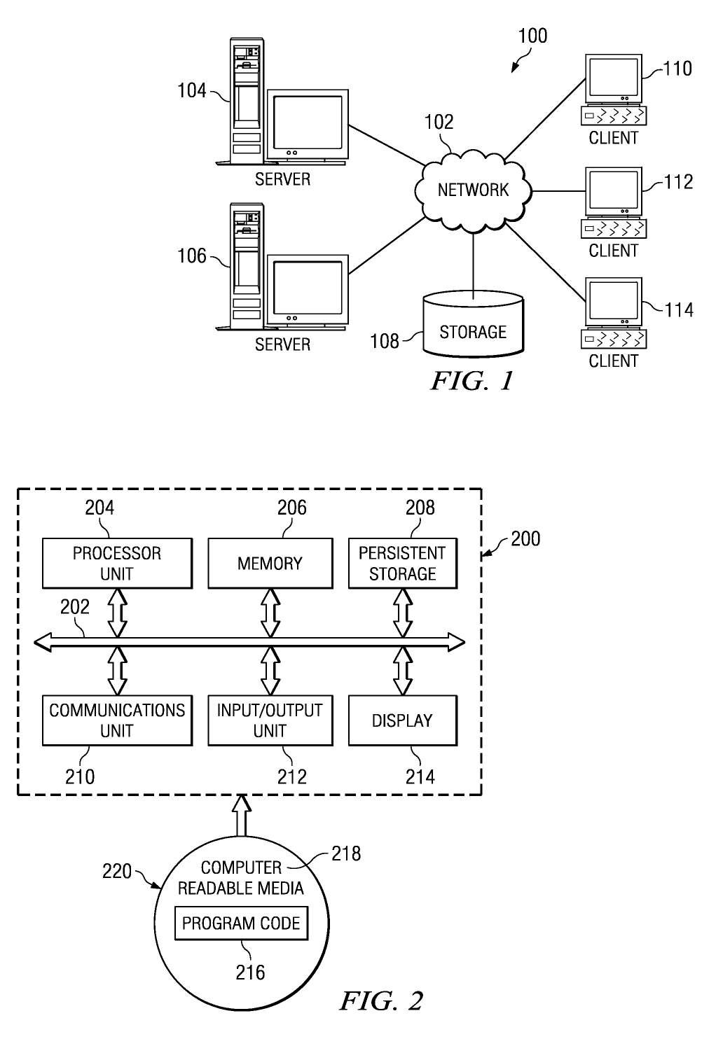

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

As previously mentioned, the operating system on the data processing system may provide various software mechanisms to protect sensitive data, such as using encryption technology to encrypt the sensitive data. However, use of an encryption file system may be prohibitively expensive in some systems, since encryption processing hinders system performance. The illustrative embodiments address this situation in data processing systems which do not employ encrypted file systems by providing a mechanism which autonomically responds and protects sensitive data when tampering is detected. The autonomic defense mechanism is triggered upon receiving a notification or alert that intruder activity has been detected in the system.

To trigger the autonomic defense mechanism, various discovery mechanisms may be used to detect the occurrence of data tampering in a data processing system. One such detection mechanism is an intrusion detection system. An intrusion detection system comprises software, hardware, or a combination of both to detect intruder activity on the network or particular hosts in the network. These intrusion detection systems include network-based systems which detect attacks in a network, or host-based systems which detect attacks on the host machine only. Based on examination of signatures or anomalies related to Internet protocols, the intrusion detection systems locate and log suspicious activity and generate alerts.

Upon receiving a notification or alert from the intrusion detection system of data tampering activity, the autonomic defense mechanism protects the data from the detected tampering activity by encrypting the data. Encryption of data is a commonly applied method that is used for denying access to sensitive information to those who, generally, should not have access. Encryption is broadly defined as using an algorithmic process to transform data into a form in which there is a low probability of assigning meaning without use of an encryption key. The encryption key or keys are only available to authorized parties. Private encryption keys are numbers that are supposed to be known only to a particular entity, i.e. kept secret.

For example, if the sensitive data is located in one or more particular folders in a file system on a node, the autonomic defense mechanism is programmed to encrypt all data stored in those particular storage locations. The encrypted data is protected by limiting access to the private encryption key to only the autonomic defense mechanism. Limited encryption and decryption access is important because data theft most often occurs within an organization by employees that should not be accessing the sensitive information, but nonetheless have access to encryption keys. The encryption key used by the autonomic defense mechanism to encrypt the sensitive data is then erased from memory. The encryption key is deleted either after a certain time period has expired or after all of the sensitive data is encrypted. Even if the intruder attack was successful (i.e., the intruder gained access to the data), the intruder would only have a limited time to read the unencrypted data or to try to recover the key before the data is encrypted by the autonomic defense mechanism.

Once the data is encrypted, the data is not available to the system until the system administrator recovers the data. The system administrator may restore the data to its unencrypted state following the attack by reloading the encryption key from a backup source onto the system. The backup source may be a different secure computer that serves only as a key repository, or a removable medium such as a diskette or CD-ROM that is stored separately from the computer (e.g., in a safe). The autonomic defense mechanism may then unencrypt the encrypted data using the reloaded encryption key.

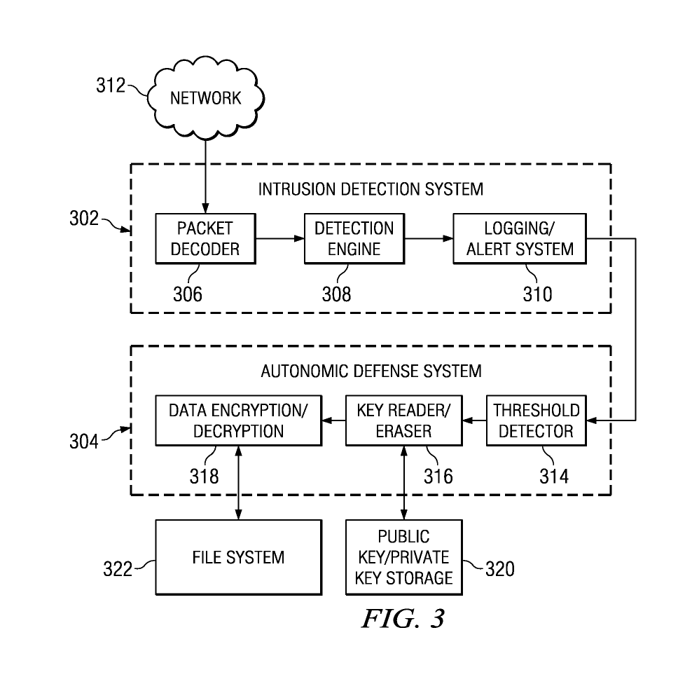

Turning now to FIG. 3, a block diagram of exemplary components which may be used to implement the autonomic defense solution in accordance with the illustrative embodiments is shown. Data processing system 300 comprises a system which maintains the data in unencrypted form. Data processing system 300 is an example of data processing system 200 shown in FIG. 2 and depicts an exemplary intrusion detection system 302 and autonomic defense system 304 used for implementing aspects of the illustrative embodiments.

Intrusion detection system 302 detects the presence of suspicious activity on data processing system 300. In this illustrative example, intrusion detection system 302 is a widely-used intrusion detection system known as Snort. Snort is an open source network intrusion detection system used to scan data on a network. Snort sensors are placed at various points in the data processing system and collect real time traffic information about the network. Snort uses protocol analysis and content pattern matching to detect a variety of attacks and probes, such as buffer overflows, stealth port scans, common gateway interface (CGI) attacks, server message block (SMB) probes, etc. While a particular intrusion detection system is depicted in FIG. 3, one of ordinary skill in the art would understand that any intrusion detection system capable of detecting suspicious activity and generating notifications and alerts may also be used without departing from the scope of the invention.

Intrusion detection system 302 architecture comprises three subsystems: packet decoder 306, detection engine 308, and logging and alerting subsystem 310. An external packet capturing library (libpcap) is used to sniff and capture data packets in raw form from network 312. Packet decoder 306 receives the captured packets from the library and translates specific protocol elements into an internal data structure. After the decode is completed, the packets are passed to detection engine 308.

Detection engine 308 performs tests on each packet to detect intrusions. Detection engine 308 applies a set of detection rules against the decoded packets. A rule that matches a decoded packet in the detection engine triggers the action specified in the rule definition.

Logging and alerting subsystem 310 generates alerts to provide notification of suspicious activity on the data processing system. Logging and alerting subsystem 310 may also log packet information in a decoded (human readable) format or a binary format. When an alert is generated, logging and alerting subsystem 310 sends the alert to autonomic defense system 304. Generally, the alert will comprise information about which rule was violated and details of the violation, such as the time of day, the originating network, the target host, the target port and/or targeted service.

Autonomic defense system 304 is triggered in response to receiving an alert from logging and alerting subsystem 310. Autonomic defense system 304 comprises threshold detector 314, key reader/eraser mechanism 316, and data encryption/decryption module 318. Threshold detector 314 receives the alert and compares the information in the alert against a pre-defined defense threshold. A pre-defined defense threshold is a minimum level of detected suspicious activity for which defensive action is taken. Threshold detector 314 will have knowledge about the particular intrusion detection system used. For example, if the Snort intrusion detection system is employed, within Snort itself, an extension may be implemented on Snort's react keyword which initiates the data encryption task. Threshold detector 314 keeps track of the number of alerts over a period of time, weighted with the severity of the rule. Consequently, if a highly critical rule (e.g., ssh allowed root to log in) generates an alert, the pre-defined defense threshold may be tripped. If a less critical rules generates X number of alerts within 30 seconds, the pre-defined defense threshold may be tripped. In another example, for U.S. government web sites, if a large number of alerts were generated from hosts in China, the pre-defined defense threshold may be tripped.

If threshold detector 314 determines that the information in the alert meets or exceeds the pre-defined threshold value, autonomic defense system 304 takes action to protect the sensitive data in data processing system 300. Key reader/eraser mechanism 316 obtains an encryption key by reading the encryption key stored in public key/private key persistent storage 320. Public key/private key persistent storage 320 is an example of persistent storage 208 in FIG. 2. Public key/private key persistent storage 320 contains encryption keys generated using any known key generating software. As herein defined, encryption key refers to one or more keys, elements, algorithms, or methods that may be used to encrypt and/or decrypt data in file system 322.

Key reader/eraser mechanism 316 then reads the encryption key into memory of data processing system 300. For instance, key reader/eraser mechanism 316 may read the encryption key into memory 206 in FIG. 2. Once the encryption key has been loaded into memory, key reader/eraser mechanism 316 removes or erases that encryption key from public key/private key persistent storage 320. Consequently, the encryption key is currently only present in memory.

Data encryption/decryption module 318 uses the encryption key in memory to encrypt the sensitive data in file system 322. Encryption of the sensitive data may be performed using any known encryption method. Data encryption/decryption module 318 may encrypt all of the data located in file system 322, or alternatively encrypt the sensitive data located in one or more particular folders in file system 322.

Once data encryption/decryption module 318 has encrypted the data, the encryption key used to encrypt the data is erased from memory. Thus, the encryption key is no longer present in persistent storage 208 or memory 206 in FIG. 2. As the data is now encrypted and the encryption key is not available to the operating system, the operating system cannot access the data until the system administrator recovers the data. However, an intruder also cannot access the encrypted data or obtain the encryption key to unencrypt the data.

At a point in time following the attack, autonomic defense system 304 may return the encrypted data to its unencrypted state, which would allow the operating system to have access to the data. To restore the data, the system administrator initiates autonomic defense system 304 to obtain the encryption key from a backup source onto the system. The system administrator may obtain the key from a secure server or secure media (CD-ROM, diskette, USB key, etc.) for unencrypting the data. Once autonomic defense system 304 loads the key into memory, data encryption/decryption module 318 may use the reloaded key to unencrypt the data in file system 322.

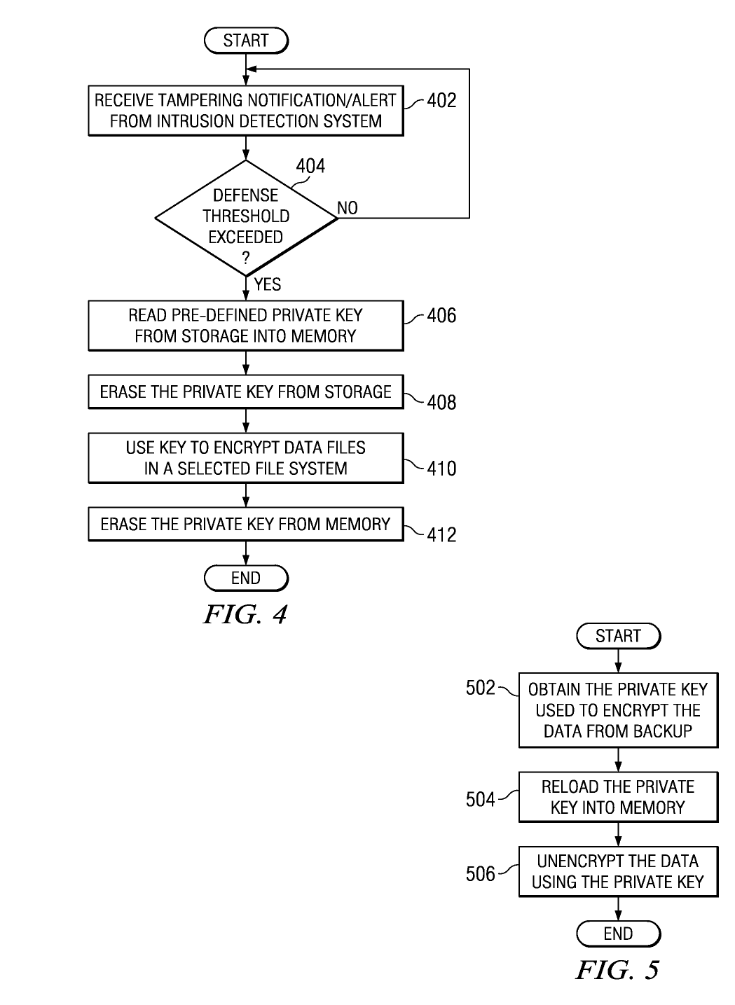

FIG. 4 is a flowchart of a process for triggering an autonomic defense when tampering is detected in a data processing system in accordance with the illustrative embodiments. An intrusion detection system may be employed in the data processing system to detect data tampering by an unauthorized user. The process in FIG. 4 describes the actions of autonomic defense system 304 in FIG. 3, upon receiving notification of suspicious activity from the intrusion detection system, to prevent an unauthorized user from accessing the data.

The process begins with the autonomic defense system receiving notification of possible data tampering from the intrusion detection system (step 402). Upon receiving the notification, the autonomic defense system makes a determination as to whether the information in the notification received from the intrusion detection system meets or exceeds a defense threshold (step 404). If the autonomic defense system determines that the defense threshold has not been met or exceeded (‘no’ output of step 404), the process loops back to step 402 to wait for another notification from the intrusion detection system.

If the autonomic defense system determines that the defense threshold has been met or exceeded (‘yes’ output of step 404), the autonomic defense system reads a pre-defined encryption key from a storage location into memory (step 406). The autonomic defense system then erases the key from the storage location (step 408). The autonomic defense system then encrypts the selected sensitive data files in the file system using the key (step 410). Once the data files are encrypted, the autonomic defense system erases the key from memory (step 412).

At this point, the sensitive data has been encrypted, and the key used to encrypt the data has been erased from both the original storage location and from memory. Consequently, an unauthorized user cannot read the data, since the data is now encrypted. However, in some situations, the unauthorized user may be successful in accessing the data in the data processing system prior to the data being encrypted by the autonomic defense system. In this situation, the unauthorized user only has a limited time to recover the key from memory or read the data while it is unencrypted. Once the autonomic defense mechanism encrypts the data and erases the key, the unauthorized user is prevented from accessing the data.

FIG. 5 is a flowchart of a process for recovering data responsive to execution of an autonomic defense in accordance with the illustrative embodiments. The process in FIG. 5 describes the actions taken by autonomic defense system 304 in FIG. 3 when the system administrator wants to restore the data in the data filing system to its unencrypted state. The data processing system is unable to access the encrypted data until the system administrator initiates the data recovery described in FIG. 5.

The process begins when the system administrator instructs the autonomic defense system to obtain the key used to encrypt the data from a backup source (step 502). The autonomic defense system loads the key into memory (step 504). The autonomic defense system then uses the key to unencrypt the encrypted data (step 506). Consequently, the encrypted data is restored to its unencrypted state and the data processing system is now able to access the data.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for autonomic defense when tampering is detected in a data processing system, the computer implemented method comprising:
receiving notification of data tampering activity in the data processing system;
responsive to a determination that the data tampering activity exceeds a threshold, reading an encryption key from a persistent storage location into memory;
erasing the encryption key from the persistent storage location;
encrypting data in the data processing system using the encryption key to form encrypted data; and
erasing the encryption key from memory.

2. The computer implemented method of claim 1, further comprising:
responsive to receiving an instruction to restore the encrypted data to an unencrypted form, obtaining the encryption key used to encrypt the encrypted data from a backup storage location;
reloading the encryption key into memory; and
unencrypting the encrypted data using the reloaded encryption key.

3. The computer implemented method of claim 1, wherein the notification is received from an intrusion detection system.

4. The computer implemented method of claim 1, wherein data tampering activity includes unauthorized modification or destruction of data in the data processing system.

5. The computer implemented method of claim 1, wherein encrypting data in the data processing system comprises encrypting data in one or more specific folders in a file system.

6. The computer implemented method of claim 1, wherein the backup storage location is one of a secure server or a removable storage media.

7. The computer implemented method of claim 1, wherein the encrypted data is accessible only with the encryption key.

8. A data processing system for autonomic defense when tampering is detected in the data processing system, the data processing system comprising:
abus;
a storage device connected to the bus, wherein the storage device contains computer usable code;
at least one managed device connected to the bus;
a communications unit connected to the bus; and
a processing unit connected to the bus, wherein the processing unit executes the computer usable code to receive notification of data tampering activity in the data processing system; read, in response to a determination that the data tampering activity exceeds a threshold, an encryption key from a persistent storage location into memory; erase the encryption key from the persistent storage location; encrypt data in the data processing system using the encryption key to form encrypted data; and erase the encryption key from memory.

9. The data processing system of claim 8, wherein the processing unit further executes the computer usable code to obtain, in response to receiving an instruction to restore the encrypted data to an unencrypted form, the encryption key used to encrypt the encrypted data from a backup storage location; reload the encryption key into memory; and unencrypt the encrypted data using the reloaded encryption key.

10. The data processing system of claim 8, wherein the notification is received from an intrusion detection system.

11. The data processing system of claim 8, wherein data tampering activity includes unauthorized modification or destruction of data in the data processing system.

12. The data processing system of claim 8, wherein encrypting data in the data processing system comprises encrypting data in one or more specific folders in a file system.

13. The data processing system of claim 8, wherein the backup storage location is one of a secure server or a removable storage media.

14. A computer program product for autonomic defense when tampering is detected in a data processing system, the computer program product comprising:
a computer usable medium having computer usable program code tangibly embodied thereon, the computer usable program code comprising:
computer usable program code for receiving notification of data tampering activity in the data processing system;
computer usable program code for reading, in response to a determination that the data tampering activity exceeds a threshold, an encryption key from a persistent storage location into memory;
computer usable program code for erasing the encryption key from the persistent storage location;
computer usable program code for encrypting data in the data processing system using the encryption key to form encrypted data; and
computer usable program code for erasing the encryption key from memory.

15. The computer program product of claim 14, further comprising:
computer usable program code for obtaining, in response to receiving an instruction to restore the encrypted data to an unencrypted form, the encryption key used to encrypt the encrypted data from a backup storage location;
computer usable program code for reloading the encryption key into memory; and
computer usable program code for unencrypting the encrypted data using the reloaded encryption key.

16. The computer program product of claim 14, wherein the notification is received from an intrusion detection system.

17. The computer program product of claim 14, wherein data tampering activity includes unauthorized modification or destruction of data in the data processing system.

18. The computer program product of claim 14, wherein the computer usable program code for encrypting data in the data processing system comprises computer usable program code for encrypting data in one or more specific folders in a file system.

19. The computer program product of claim 14, wherein the backup storage location is one of a secure server or a removable storage media.

20. The computer program product of claim 14, wherein the encrypted data is accessible only with the encryption key.
